(19) United States
(12) Patent Application Publication
(10) Pub. No.: US 2026/0166876 A1
(43) Pub. Date: Jun. 18, 2026

(54) DRIVE SIGNAL GENERATION CIRCUIT, PRINTING ELEMENT SUBSTRATE, PRINT HEAD, AND PRINTING APPARATUS

(71) Applicant: CANON KABUSHIKI KAISHA, Tokyo (JP)

(72) Inventor: HIDENORI YAMATO, Tokyo (JP)

(21) Appl. No.: 19/412,534

(22) Filed: Dec. 8, 2025

(30) Foreign Application Priority Data
Dec. 18, 2024 (JP) 2024-222328

(51) Int. Cl. B41J 2/045

(52) U.S. Cl. CPC B41J 2/04551; B41J 2/04573; B41J 2/0458; B41J 2/04588

(57) ABSTRACT

A generation device is used in a substrate including a plurality of first print elements, a plurality of second print elements, a plurality of first drive elements configured to drive the plurality of first print elements, and a plurality of second drive elements configured to drive the plurality of second print elements. The generation device generates a first drive signal, stands by for a standby period, and then generates a second drive signal. At least one of the first drive elements operates based on the first drive signal or the second drive signal. At least one of the second drive elements operates based on the first drive signal or the second drive signal.

### BACKGROUND

### Field of the Technology

The aspect of the embodiments relates to a drive signal generation circuit, a printing element substrate, a print head, and a printing apparatus.

### Description of the Related Art

A following system is known as a system in which an inkjet print head (also referred to as “print head”) is driven. Electro-thermal transducing elements (heaters) are provided in portions communicating with ejection ports from which ink droplets are ejected. A current is supplied to these heaters to cause the heaters to generate heat, and the ink droplets are ejected by film boiling of the inks. A switching element is connected to each of the heaters, and the current flows to the heater by turn-on of the switching element according to data. In order to drive the multiple heaters provided to correspond to the multiple ejection ports aligned in a row, there is generally used a system in which the multiple heaters are divided into multiple blocks, and the heaters in each block are subjected to time division drive.

The number of elements driven in a substrate tends to increase with increases in image quality and speed of printing in the recent years, and supplying of electric power to the printing element substrate has become a problem. In order to suppress a peak of a current flowing to the printing element substrate, drive timings are shifted from one another in a time-division block time period, and the current peak is suppressed. As a method of suppressing an increase in the number of terminals, as described in Japanese Patent Laid-Open No. 2011-235531, there is a method in which a circuit configured to generate drive signals is mounted in a head element substrate. Furthermore, for suppression of a circuit scale, as described in Japanese Patent Laid-Open No. 2020-189448, multiple drive signals are generated in one element drive signal generation circuit, and this reduces a current peak while reducing the number of terminals and the circuit scale. However, in the case where the drive signals are successively generated in a situation where the number of heaters to be simultaneously turned on (also referred to as “simultaneous turn-on number”) is large, energy fluctuation in driving of the first heater affects driving of the next heater, and this affects an ejection characteristic. This applies not only to the case where the heaters are used as printing elements, but also to the case where piezoelectric elements are used as the printing elements.

### SUMMARY

A generation device used in a substrate, the substrate comprising a plurality of first print elements, a plurality of second print elements, a plurality of first drive elements configured to drive the plurality of first print elements, and a plurality of second drive elements configured to drive the plurality of second print elements. The generation device generates a first drive signal, stands by for a standby period, and then generates a second drive signal, and at least one of the first drive elements operates based on the first drive signal or the second drive signal, and at least one of the second drive elements operates based on the first drive signal or the second drive signal.

Features of the disclosure will become apparent from the following description of embodiments with reference to the attached drawings. The following description of embodiments is described by way of example.

### BRIEF DESCRIPTION OF THE DRAWINGS

FIG. 1 is a perspective diagram illustrating an example of an outer appearance configuration of an inkjet printing apparatus according to an embodiment of the disclosure;

FIG. 2 is a functional block diagram illustrating a functional configuration of the printing apparatus illustrated in FIG. 1;

FIG. 3 is a circuit diagram illustrating a circuit of a printing element substrate;

FIG. 4 is a timing chart illustrating signals received by an LVDS system and signals generated in an internal circuit of the printing element substrate;

FIG. 5 is a circuit diagram illustrating a drive signal generation circuit in a first embodiment;

FIG. 6 is a timing chart illustrating detailed timings of signals in one block time period in the first embodiment;

FIG. 7A is an image diagram illustrating a drive voltage and a drive current in the first embodiment;

FIG. 7B is an image diagram illustrating a drive voltage and a drive current in the first embodiment;

FIG. 7C is an image diagram illustrating a drive voltage and a drive current in the first embodiment;

FIG. 8 is a circuit diagram illustrating a drive signal generation circuit in a second embodiment;

FIG. 9 is a circuit diagram illustrating a circuit of a printing element substrate;

FIG. 10 is a circuit diagram illustrating a configuration of a drive signal selection circuit; and

FIG. 11 is a timing chart illustrating an operation of a printing element substrate illustrated in FIG. 9.

### DESCRIPTION OF THE EMBODIMENTS

Embodiments are explained below in detail with reference to the attached drawings. Note that the following embodiments do not limit the disclosure according to the scope of claims. Although multiple features are described in the embodiments, not all of these multiple features are necessarily essential for the disclosure, and the multiple features may be combined in any combination. Moreover, identical or similar configurations are denoted by identical reference numerals in the attached drawings, and overlapping explanation is omitted.

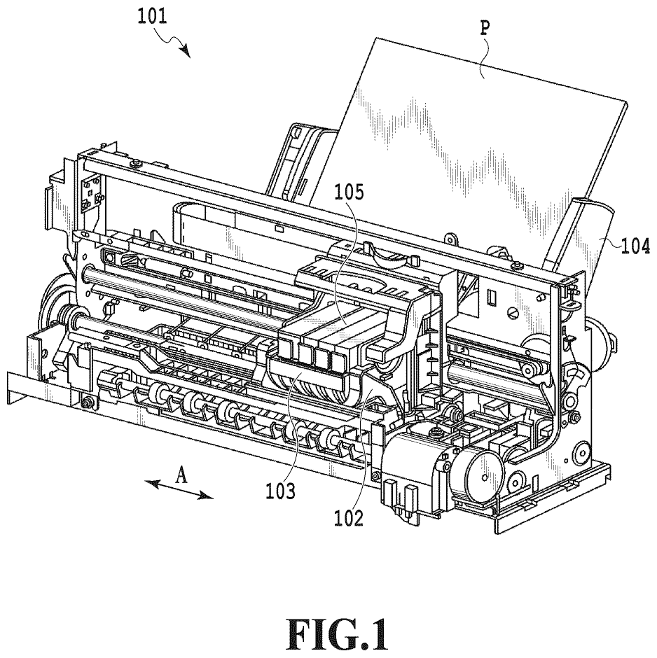

FIG. 1 is an outer appearance perspective diagram illustrating an outline of a configuration of a printing apparatus that performs printing by using an inkjet print head (hereinafter, also simply referred to as “print head”) that is a typical embodiment of the disclosure.

As illustrated in FIG. 1, in an inkjet printing apparatus (also simply referred to as “printing apparatus”) 101, a print head 103 that performs printing by ejecting inks in an inkjet system is mounted in a carriage 102. The printing apparatus 101 performs printing by causing the carriage 102 to reciprocally move in the direction of the arrow A. The printing apparatus 101 feeds a print medium P such as print paper via a feeding mechanism 104, conveys the print medium P to a print position, and performs printing by ejecting the inks from the print head 103 to the print medium P at this print position.

An ink tank 105 that stores the inks to be supplied to the print head 103 is also mounted in the carriage 102 of the printing apparatus 101 in addition to the print head 103. The ink tank 105 can be attached to and detached from the carriage 102.

The printing apparatus 101 illustrated FIG. 1 is capable of performing color printing, and four ink cartridges storing inks of magenta (M), cyan (C), yellow (Y), and black (K), respectively, are mounted in the carriage 102 to this end. These four ink cartridges can be independently attached and detached.

The print head 103 of the embodiment adopts an inkjet system in which the inks are ejected by using thermal energy. To this end, the print head 103 includes print elements (heaters). The print elements are provided to correspond to ejection ports, respectively. A pulse voltage is applied to corresponding print elements according to a print signal, and this causes the print elements to eject the inks from the corresponding ejection ports. Note that the printing apparatus is not limited to the serial type printing apparatus described above, and the disclosure can be also applied to a so-called full-line type printing apparatus in which print heads (line heads) in each of which ejection ports aligned in a width direction of the print medium is arranged in a conveyance direction of the print medium.

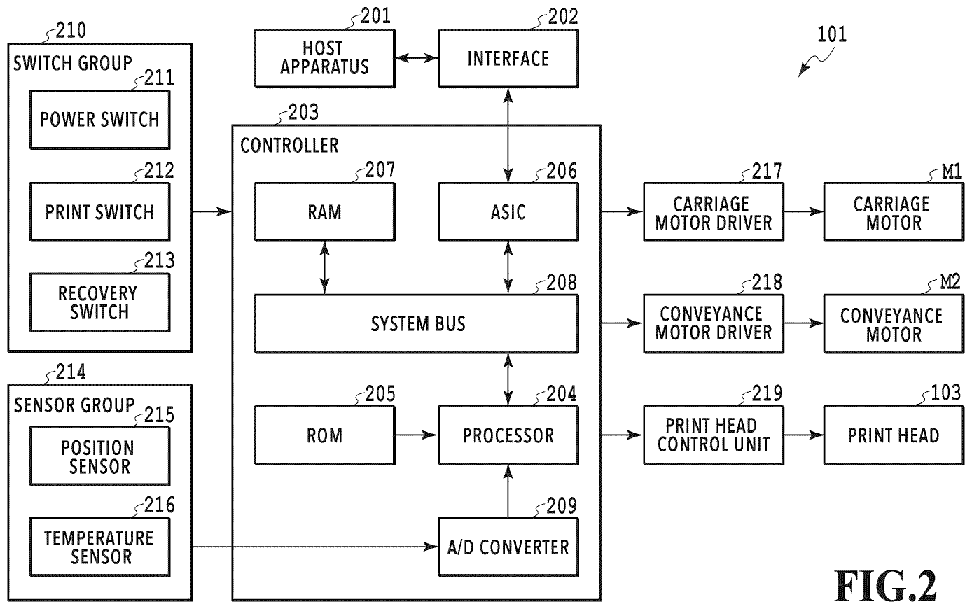

FIG. 2 is a block diagram illustrating a control configuration of the printing apparatus 101 illustrated in FIG. 1.

As illustrated in FIG. 2, a controller 203 includes a processor 204 such as an MPU, a ROM 205, an application specific integrated circuit (ASIC) 206, a RAM 207, a system bus 208, and an A/D converter 209. The ROM 205 stores a program corresponding to a control sequence to be described later, a necessary table, and other pieces of fixed data. The ASIC 206 generates control signals for controlling a carriage motor M1, controlling a conveyance motor M2, and controlling the print head 103. The RAM 207 is used as an expanding region of image data, a work region for executing programs, and the like. The system bus 208 exchanges data by connecting the processor 204, the ASIC 206, and the RAM 207 to one another. The A/D converter 209 receives analog signals from a sensor group to be explained later, performs A/D conversion on the analog signals, and supplies digital signals to the processor 204.

Moreover, in FIG. 2, reference numeral 201 denotes a host apparatus corresponding to a host illustrated in FIG. 1 or an MFP that is a supply source of the image data. The image data, commands, statuses, and the like are exchanged between the host apparatus 201 and the printing apparatus 101 via an interface (I/F) 202 by means of packet communication. Note that an USB interface may be further provided separately from a network interface as the interface 202 to allow reception of bit data and rasta data serially transferred from the host.

Moreover, reference numeral 210 denotes a switch group. The switch group 210 includes a power switch 211, a print switch 212, and a recovery switch 213.

Reference numeral 214 denotes a sensor group for detecting an apparatus state. The sensor group 214 includes a position sensor 215 and a temperature sensor 216. In the embodiment, photo sensors (not illustrated) that detect ink remaining amounts are also provided. Moreover, reference numeral 217 denotes a carriage motor driver that drives the carriage motor M1 for reciprocal scanning of the carriage 102 in the direction of the arrow A. Reference numeral 218 indicates a conveyance motor driver that drives the conveyance motor M2 for conveyance of the print medium P. Reference numeral 219 denotes a print head control unit for control of the print head 103.

The ASIC 206 transfers data for driving the print elements (heaters for ink ejection) to the print head 103 while directly accessing a storage region of the RAM 207 in print scanning by the print head 103. In addition, the printing apparatus 101 includes a display unit (not illustrated) formed of an LCD or an LED as a user interface.

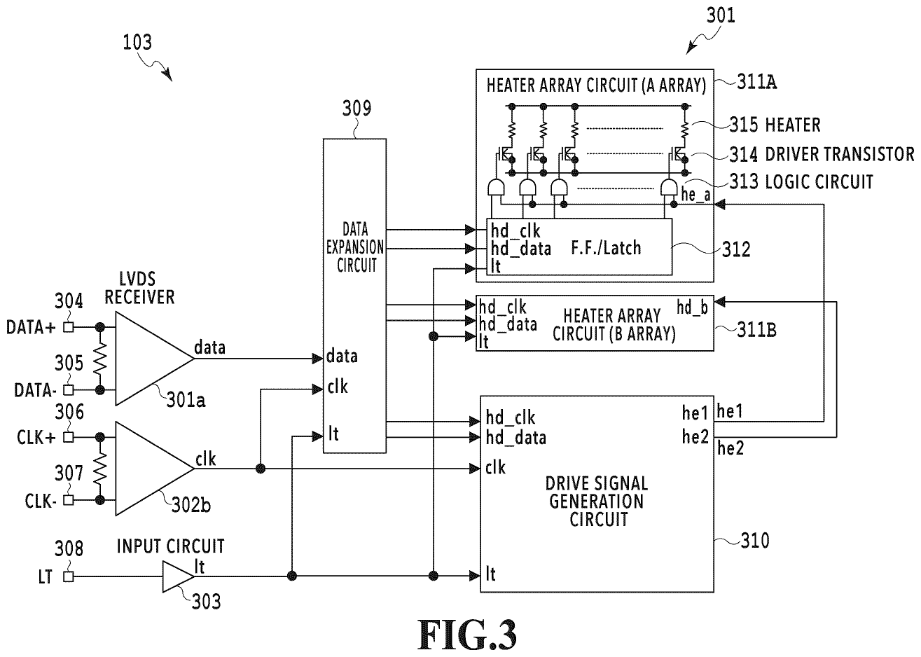

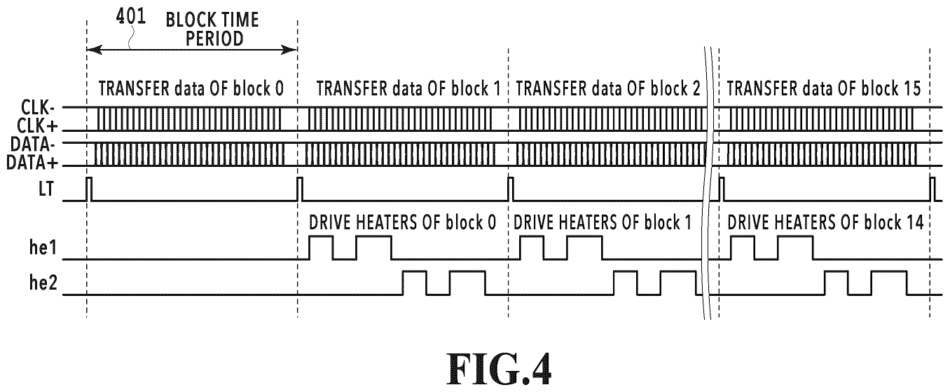

### Explanation of Configuration of Printing Element Substrate (FIGS. 3 to 4)

FIG. 3 is a circuit configuration diagram of a printing element substrate 301 included in the print head 103.

The printing element substrate 301 receives data from the controller 203 of the printing apparatus by using a low voltage differential signal (LVDS) system. An LVDS receiver 302a receives data signals (DATA+ and DATA−) through input terminals 304 and 305, and outputs internal data data. A LVDS receiver 302b receives clock signals (CLK+ and CLK−) through input terminals 306 and 307, and outputs an internal clock clk. The internal data data and the internal clock clk are inputted into a data expansion circuit 309, and are expanded in function circuits for the internal data data and the internal clock clk, respectively. The printing element substrate 301 generally receives a latch signal (LT) via an input terminal 308 as a serial signal, and an input circuit (OP amplifier) 303 amplifies the latch signal, and outputs an lt signal.

Multiple print elements (heaters 315) that heat the inks in assigned nozzles to eject the inks and multiple drive elements (driver transistors 314) that drive the multiple heaters 315 are mounted in heater array circuits 311A and 311B. Transistors such as MOSFETs are used as the driver transistors 314. Moreover, logic circuits 313 (AND circuit in this case) and flip-flop circuits (shift registers)/latch circuits 312 that are operated by signals transmitted from the outside (main body portion of the printing apparatus 101) are mounted in the heater array circuits 311A and 311B. In the example illustrated in FIG. 3, multiple heaters 315 are mounted while being divided and aligned in two rows, and the heater array circuits 311A and 311B that drive these heaters 315 are provided for the respective rows of the nozzles. Moreover, a drive signal generation circuit 310 is a circuit that generates drive signals defining drive time periods of the heaters. In the heater array circuit 311A, a desired heater can be driven for a desired time period by taking AND between the latch circuit 312 and an he1 signal that is an output signal of the drive signal generation circuit 310.

FIG. 4 illustrates a timing chart of the signals received by the LVDS system and signals generated in an internal circuit of the printing element substrate 301. As illustrated in FIG. 4, the he1 signal and an he2 signal are periodically repeated at a cycle having a duration of a block time period. FIG. 4 illustrates an example in which time division drive is performed by dividing the multiple driver transistors corresponding to the multiple heaters into 16 blocks (blocks 0 to 15). Data transmission and drive of the print elements are simultaneously performed in a block time period 401 of one cycle in the case where the print elements are driven in the time division drive. In block 1, the print elements are driven based on data sent in block 0, and at the same time, data for drive in block 2 is transmitted. The shift registers/latch circuits 312 are provided in the latch circuits 312 of the heater array circuits 311A and 311B, and hd_clk and hd_data are transmitted to the shift registers of the heater array circuits 311A and 311B. Moreover, a shift register/latch circuit is also provided in the drive signal generation circuit 310, and he_clk and he_data are transmitted to the shift register of the drive signal generation circuit 310.

In the next block, the internal signals hd_data transferred in the previous block are stored and held in the corresponding latch circuits 312 of the heater array circuits 311A and 311B, and the print elements to be driven are selected at a timing at which a pulse of LT rises to high (high level).

Moreover, the internal signal he_data transferred in the previous block is stored and held in the latch circuit (not illustrated) of the drive signal generation circuit 310.

The drive signal generation circuit 310 counts the internal clock clk with an internal counter (not illustrated), and generates drive signals corresponding to data transferred in the previous block. As also described in Japanese Patent Laid-Open No. 2020-189448, resetting the same counter after the counting of the he1 signal and generating the he2 signal enables generation of multiple drive signals in one drive signal generation circuit 310, and the circuit scale can be reduced.

### First Embodiment

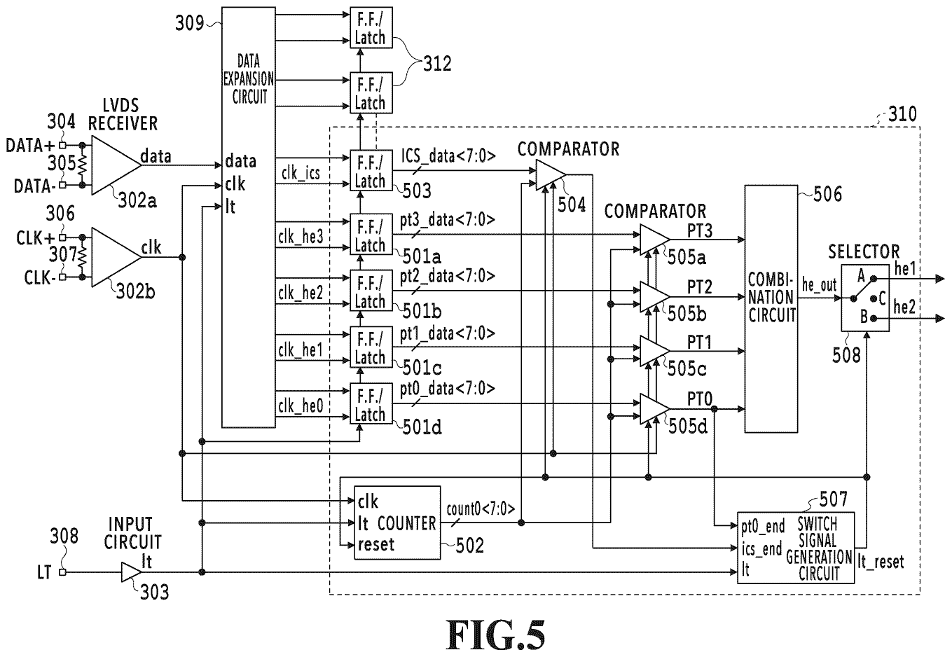

FIG. 5 is a circuit diagram illustrating the drive signal generation circuit 310 according to the first embodiment. Note that, in FIG. 5, the same constituent elements as those already explained with reference to FIG. 3 are denoted by the same reference numerals, and explanation thereof is omitted.

The drive signal generation circuit 310 includes flip-flop/latch circuits 501 and 503 in which drive signal data is stored, a counter 502, comparators 504 and 505a to 505d, a combination circuit 506, a switch signal generation circuit 507, and a drive signal selection circuit (also referred to as “selector”) 508.

Data defining each of edges PT3/2/1/0 of the drive signals and data defining an interval period between the drive signals among pieces of data received from the controller 203 are transmitted from the data expansion circuit 309 to the flip-flop/latch circuits 501 and 503. The comparator 505a compares count<7:0> that is a counter value of the counter 502 and pt3_data<7:0> that is the drive signal data transmitted from the data expansion circuit 309 with each other. The counter 502 starts counting from an initial value (zero in the embodiment). In the case where the counter value count<7:0> of the counter 502 reaches the drive signal data pt3_data<7:0>, a drive signal PT3 that changes from low to high is generated from the comparator 505a at a timing of a rising edge of the next internal clock clk.

Similarly, the comparator 505b compares count<7:0> that is the counter value of the counter 502 and pt2_data<7:0> that is the drive signal data transmitted from the data expansion circuit 309 with each other. In the case where the counter value count<7:0> of the counter 502 reaches the drive signal data pt2_data<7:0>, a drive signal PT2 that changes from low to high is generated from the comparator 505b at a timing of the rising edge of the next internal clock clk.

Moreover, similarly, the comparator 505c compares count<7:0> that is the counter value of the counter 502 and pt1_data<7:0> that is the drive signal data transmitted from the data expansion circuit 309 with each other. In the case where the counter value count<7: 0> of the counter 502 reaches the drive signal data pt1_data<7: 0>, a drive signal PT1 that changes from low to high is generated from the comparator 505c at a timing of the rising edge of the next internal clock clk.

Furthermore, similarly, the comparator 505d compares count<7:0> that is the counter value of the counter 502 and pt0_data<7:0> that is the drive signal data transmitted from the data expansion circuit 309 with each other. In the case where the counter value count<7:0> of the counter 502 reaches the drive signal data pt0_data<7:0>, a drive signal PT0 that changes from low to high is generated from the comparator 505d at a timing of the rising edge of the next internal clock clk.

The combination circuit 506 calculates the drive signals PT 3/2/1/0 to generate a drive signal. The combination circuit 506 is, for example, a four-input XOR circuit. The combination circuit 506 receives results of comparison by the comparators 505a to 505d as four inputs, and outputs XOR of these four inputs as an he_out signal. The combination circuit 506 may be a circuit that verifies whether the drive signals PT3/2/1/0 change from the low level to the high level in this order, and then obtains XOR of these drive signals. The combination circuit 506, including a circuit with a configuration having the verifying function as described above and a circuit without this configuration, is referred to as composition circuit.

Moreover, the comparator 504 compares ICS_data<7:0> stored in the flip-flop/latch circuit 503 and count0<7:0> outputted from the counter 502 with each other. In the case where the count value matches ICS_data<7:0>, high is generated from the comparator 504 at a timing of the rising edge of the next internal clock clk.

The switch signal generation circuit 507 generates a switch signal lt_reset based on pt0_end and ics_end, resets the counter 502 and the comparators 504 and 505a to 505d, and performs switching of the selector 508.

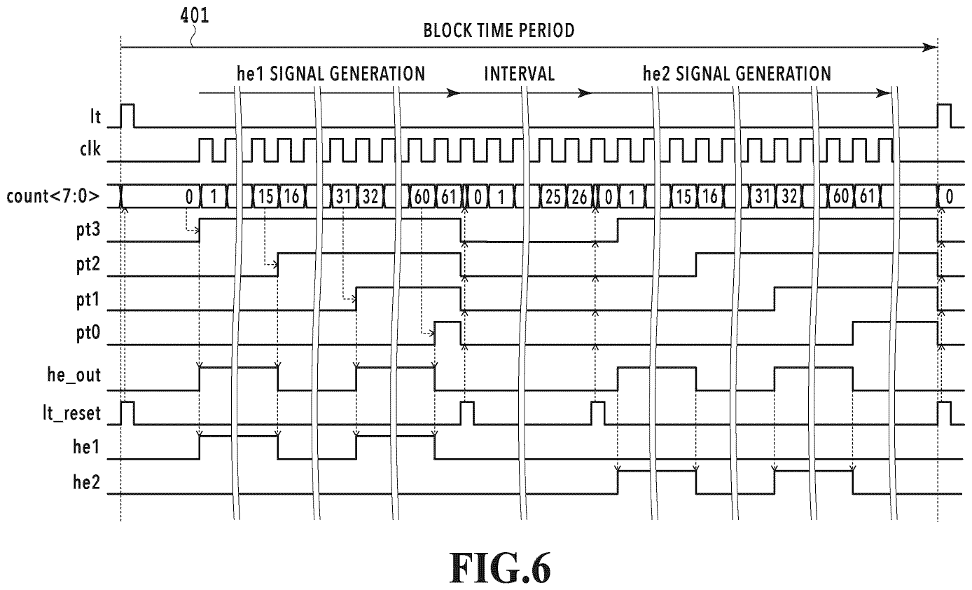

FIG. 6 illustrates a detailed timing chart of one block time period 401 illustrated in FIG. 4. The data transmitted in the previous block is latched in the latch circuit, and the selector 508 selects an A terminal at the timing of LT rising. In this case, the selector 508 selectively distributes the he_out signal to the A terminal, a B terminal, or a C terminal. The he_out signal is outputted as the he1 signal from the A terminal, outputted as the he2 signal from the B terminal, and is outputted as a not-used signal from the C terminal. As described above, PT3/2/1/0 are generated according to the data determined in the latch circuits. The combination circuit 506 generates the drive signal, and the he1 signal is outputted. FIG. 6 illustrates that, in the case where the count value count<7:0> is 0, 15, 31, and 60, the outputs pt3, pt2, pt1, and pt0 in the comparators 505a to 505d change from low to high, respectively. In the case where the counting to PT0 is completed, the switch signal lt_reset is outputted from the switch signal generation circuit 507 at a timing of the rising edge of the next internal clock clk, and the counter 502 and the comparators 504 and 505a to 505d are reset. Moreover, the switch signal generation circuit 507 sets the selector 508 to open output (selects the C terminal with no output destination).

The counter 502 restarts the counting after being reset to the initial value, and counts the interval period between the drive signals corresponding to ICS_data<7:0>. FIG. 6 illustrates an example in the case where ICS_data<7:0> is 26. In the case where the counting of the count number ICS_data<7:0> corresponding to the interval period by the counter 502 is completed, the switch signal lt_reset is outputted from the switch signal generation circuit 507 at the timing of the rising edge of the next internal clock clk. Then, the counter 502 and the comparators 504 and 505a to 505d are reset. Moreover, the switch signal generation circuit 507 causes the selector 508 to select the B terminal.

Next, the counter 502 re-restarts the counting from the initial value from the next internal clock clk, and operations similar to the he1 signal generation is repeated. The he2 signal with the same pulse width as the he1 signal can be thereby generated. The selector 508 is reset at the next LT rising, and selects the A terminal.

For example, in the case where 16 blocks (block 0 to 15) are driven at 18 kHz, one block time period 401 is about 3.47 μs. Assume that 0.1 μs or more is necessary as a time period from rising of the lt signal to rising of the first internal clock clk. Moreover, assume that 0.4 μs or more is necessary from the end of the he2 signal to the rising of the next lt signal. In this case, a transmission time period of the remaining internal clocks clk is 2.97 μs. Each of the signals he1 and he2 has a double-pulse waveform, and in the case where a width of one double pulse is 1.2 μs, a standby period can be set to 0.57 μs at maximum. In the case where LVDS is 50 MHz (one clk cycle is 20 ns), the standby period can be set to about 0.57 μs by setting ICS_data to 26. Here, 0.57 μs includes one clk from pt0 to the switch signal lt_reset and one clk from the switch signal lt_reset at the end of the standby period to the start of the he2 signal. In the case where LVDS is 75 MHz (one clk cycle is 13.3 ns), the standby period can be set to about 0.57 μs by setting ICS_data to 40.

As described above, the waveforms of the he1 signal and the he2 signal are determined by the positions of the four edges PT3/2/1/0. Moreover, the position of the edge PT3 is determined by the value of the data pt3_data<7:0>. The position of the edge PT2 is determined by the value of the data pt2_data<7:0>. The position of the edge PT1 is determined by the value of the data pt1_data<7:0>. The position of the edge PT0 is determined by the value of the data pt0_data<7:0>. Accordingly, the data pt3_data<7:0>, the data pt2_data<7:0>, the data pt1_data<7:0>, and the data pt0_data<7:0> are referred to as waveform data.

Moreover, the he1 signal and the he2 signal are inverted at the four edges PT3/2/1/0. Accordingly, the data pt3_data<7:0>, the data pt2_data<7:0>, the data pt1_data<7:0>, and the data pt0_data<7:0> are referred to as inversion count values.

Furthermore, the length of each of the he1 signal and the he2 signal is determined by the position of the edge PT0. Accordingly, the data pt0_data<7:0> is referred to as duration data, and the value of this data is referred to as drive signal count value.

Moreover, the standby period is determined by the data ICS_data<7:0>. Accordingly, the data ICS_data<7:0> is referred to as standby period data, and the value of this data is referred to as standby period count value.

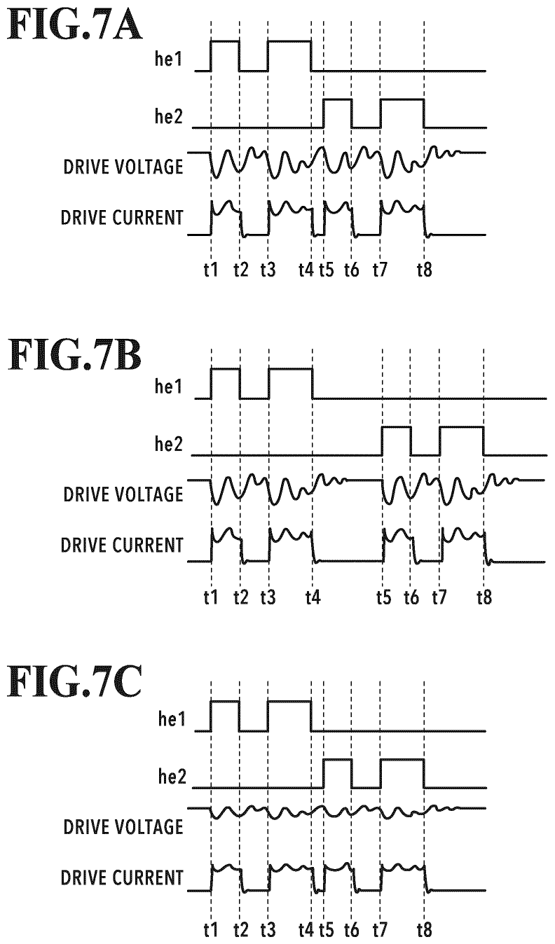

FIGS. 7A to 7C each illustrate an image of an actual drive voltage and an actual drive current for the set drive signal. FIG. 7A illustrates a case where the interval period between a signal outputted by using the he1 signal and a signal outputted by using the he2 signal is reduced in the case where the simultaneous turn-on number of the heaters is large. In the case where many heaters are simultaneously turned on, a current flows in a parasitic inductance, and immediately after a time point t1, the drive voltage undershoots, and the drive current also decreases. On the other hand, immediately after a time point t4 at which the he1 signal is turned off, the drive voltage overshoots. In the case where the subsequent he2 signal comes immediately after the he1 signal, a time point t5 comes immediately after the time point t4, and the next drive is thereby started before settling of fluctuation of the drive voltage. This causes the drive current of the he1 signal (time points t1 to t4) and the drive current of the he2 signal (time points t5 to t8) to vary from each other, and causes a difference in energy for driving the heaters. This energy difference may affect an ejection speed of the inks and generate image unevenness or the like. To counter this, as illustrated in FIG. 7B, a long interval period is set. The interval period is set such that the he2 signal is started after the settling of fluctuation of the drive voltage that has occurred before the time point t4. This can eliminate a current difference between the he1 signal and the he2 signal. Controlling the interval period from the controller depending on the simultaneous turn-on number as described above enables high image quality ejection. Moreover, FIG. 7C illustrates an image in the case where the simultaneous turn-on number is small. Since the fluctuation of the drive voltage is small in the case where the simultaneous turn-on number is small, the energy difference can be reduced to an ignorable level, and the time internal between the time point t4 and the time point t5 can be reduced. Reducing the interval between the he1 signal and the he2 signal in the case where the simultaneous turn-on number is small as described above can increase speed of printing. Note that the simultaneous turn-on number is the number of signals whose levels are high among the signals latched in the latch circuit 312 (that is, the signals to be supplied to one inputs of the logic circuits 313), and is grasped in the controller 203. Accordingly, the controller 203 can adjust the interval period depending on the grasped simultaneous turn-on number.

For example, the following case or the like is conceivable. In a high-image quality mode, since the number of applied dots is large, the image quality is prioritized by setting a long interval period. Meanwhile, in a high-speed mode, speed is prioritized by setting a short interval period while placing a limit on the simultaneous turn-on number.

Making the interval period between the drive signals variable by using the data from the outside as described above can achieve drive depending on a drive condition in one drive signal generation circuit 310. In one embodiment, only one drive signal selection circuit 508 needs to be provided for one drive signal generation circuit 310, and the drive signal generation circuit 310 with a small circuit scale can be achieved. Since each of the he1 signal, the interval period, and the he2 signal may be counted by the same counter 502 in the case where the same counter 502 is reset and used, the circuit scale of the counter 502 can be also suppressed.

Moreover, the drive signals he1 and he2 outputted to the heater array circuits 311A and 311B, respectively, may be delayed in the heater array circuits 311A and 311B for each drive element. For example, delaying the drive signals for each time division unit can prevent multiple drive elements from being simultaneously turned on and off and prevent an abrupt voltage change. In this case, the drive signals outputted from the drive signal selection circuit 508 are delayed little by little as timings of driving the drive elements.

Moreover, the switch signal lt_reset may be divided into multiple signals, and the multiple signals may be generated depending on the selection destinations of the selector 508.

Furthermore, the internal clock clk inputted into the comparators 504 and 505a to 505d may be separated for the comparator 504 and for the comparators 505a to 505d. For example, in one embodiment, the internal clock clk may be inputted from the switch signal generation circuit 507 only into the comparators 505a to 505d in the generation of the he1 signal or the generation of the he2 signal, and inputted only into the comparator 504 in the standby period.

### Second Embodiment

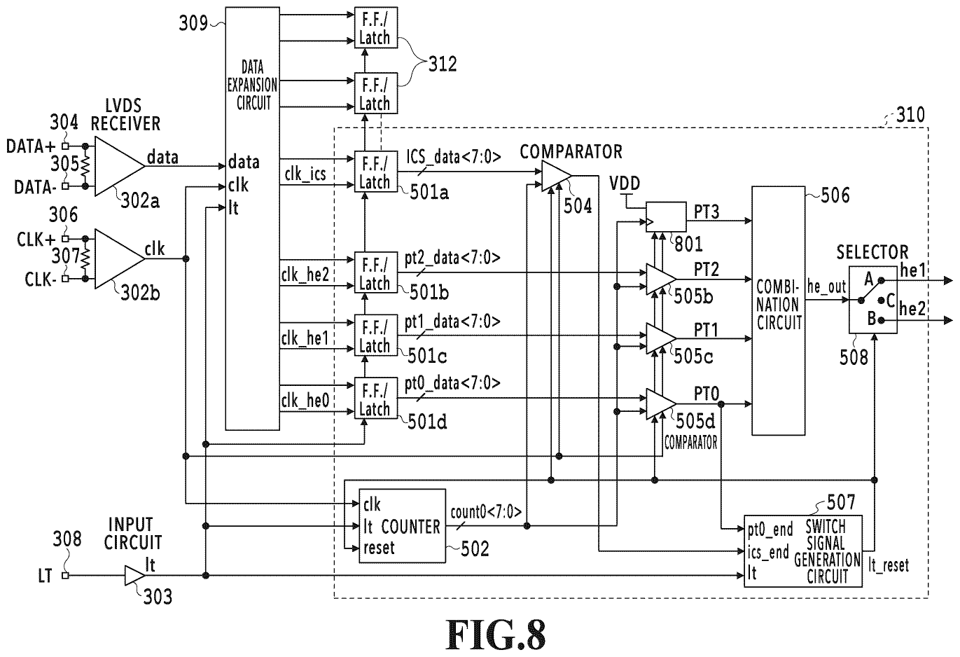

FIG. 8 is a circuit configuration diagram of the printing element substrate 301 according to a second embodiment. Note that constituent elements in FIG. 8 identical to those already explained with reference to the drawings are denoted by the same reference numerals, and explanation thereof is omitted.

As illustrated in FIG. 8, a flip-flop circuit 801 is used for the generation of the edge PT3, instead of the comparator. Data inputted into the flip-flop circuit 801 is fixed to a logic power supply VDD, and PT3 is outputted upon output from the counter 502. The edge PT3 is fixed to an initial timing of the block time period to generate the two drive signals of he1 and he2 in the block time period. This reduces a degree of freedom of setting the edge PT3. However, pt3_data<7:0> necessary for the generation of the edge PT3 becomes unnecessary, and the number of pieces of data can be reduced. Moreover, since the flip-flop/latch circuit 501a for data storage and the comparator 505a also become unnecessary, an increase in the circuit scale can be suppressed.

According to the embodiment explained above, setting one piece of drive timing information to a fixed timing can achieve reduction of the number of pieces of data and reduction of the circuit scale.

### Third Embodiment

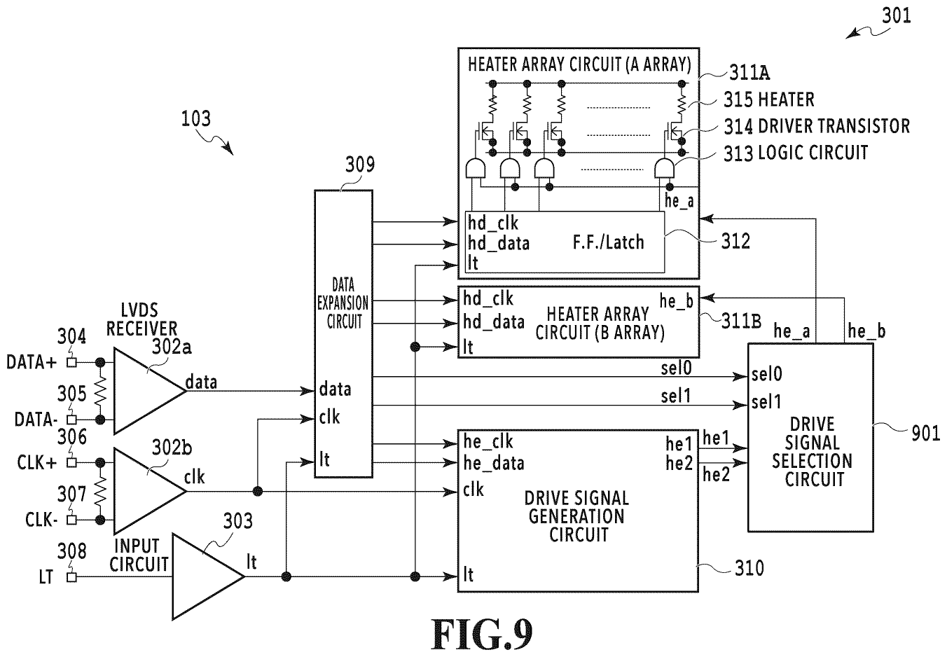

In comparison to the first embodiment, a third embodiment illustrated in FIG. 9 is the first embodiment to which a drive signal selection circuit 901 is added.

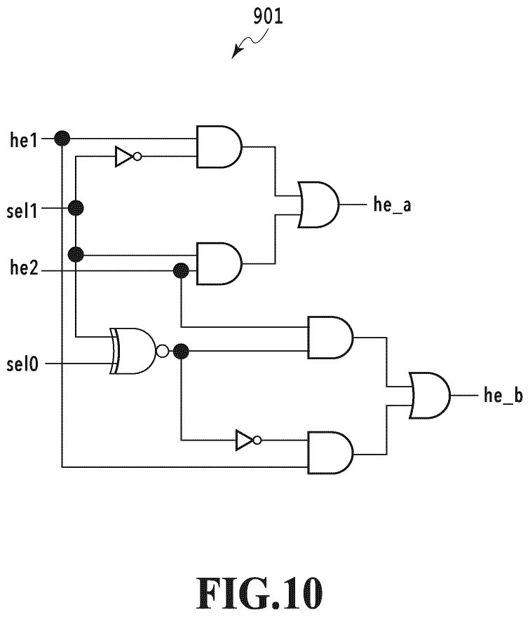

For example, the drive signal selection circuit 901 has a configuration as illustrated in FIG. 10. In the case where the drive signal selection circuit 901 has a configuration as illustrated in FIG. 10, drive signals he_a and he_b are as follows depending on selection signals sel0 and sel1.
In the case where sel0=low and sel1=low,
   he_a=he1
   he_b=he2.
In the case where sel0=high and sel1=low,
   he_a=he1
   he_b=he1.
In the case where sel0=low and sel1=high,
   he_a=he2
   he_b=he1.
In the case where sel0=high and sel1=high,
   he_a=he2
   he_b=he2.

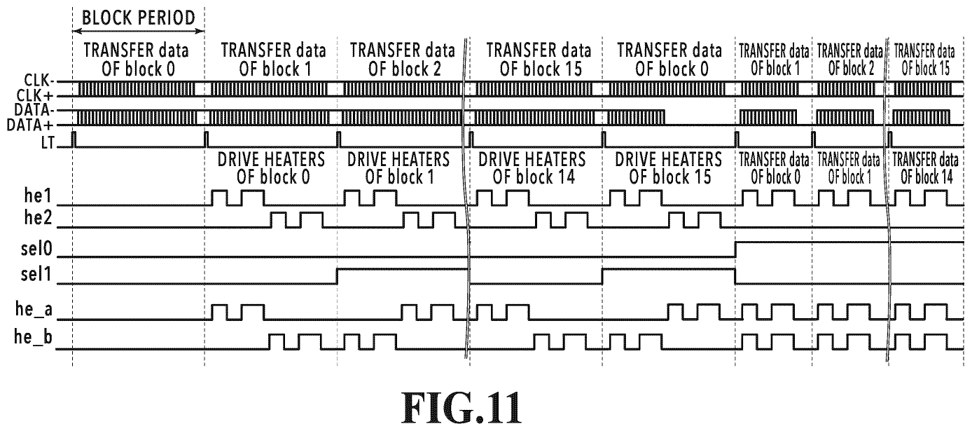

In FIG. 11, in even-number blocks from block 0 to block 14, sel0=low and sel1=low. In odd-number blocks from block 1 to block 15, sel0=low and sel1=high. In blocks subsequent to block 15, sel0=high and sel1=low.

According to the third embodiment, the drive signal he1 or the drive he2 signal can be selected as the drive signal he_a. Moreover, the drive signal he1 or the drive he2 signal can be selected as the drive signal he_b.

### Other Embodiments

The print head 103 of the above-mentioned embodiments adopts the inkjet system in which the inks are ejected by using thermal energy. Accordingly, the print head 103 includes the print elements (heaters). However, the disclosure is not limited to this, and the above-mentioned embodiments can be applied to systems other than the inkjet system such as a system in which the inks are ejected by using piezoelectric elements as the print elements.

A signal indicating the operation mode may be inputted from the outside. Moreover, the standby period may be switched depending on the operation mode. For example, data corresponding to pt0_data<7:0> is held for each operation mode, and data selected depending on the operation mode is supplied to the comparators 505. Although the operation mode may be included in serial communication DATA (accordingly, data), the operation mode may be transmitted through another transmission path.

The print head may be a print head that ejects droplets of a liquid other than the inks.

According to the disclosure, it is possible to avoid a decrease in ejection characteristic in the case where the number of print elements to be simultaneously turned on is increased.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-222328, filed Dec. 18, 2024, which is hereby incorporated by reference herein in its entirety.

What is claimed is:

1. A generation device used in a substrate, the substrate comprising a plurality of first print elements, a plurality of second print elements, a plurality of first drive elements configured to drive the plurality of first print elements, and a plurality of second drive elements configured to drive the plurality of second print elements, wherein
the generation device generates a first drive signal, stands by for a standby period, and then generates a second drive signal, and
at least one of the first drive elements operates based on the first drive signal or the second drive signal, and at least one of the second drive elements operates based on the first drive signal or the second drive signal.

2. The generation device according to claim 1, wherein the generation device periodically generates the first drive signal and the second drive signal.

3. The generation device according to claim 2, wherein a second standby period is provided between the second drive signal generated in a certain cycle and the first drive signal generated in a cycle subsequent to the certain cycle.

4. The generation device according to claim 1, wherein the generation device generates the first drive signal and the second drive signal having waveforms based on waveform data inputted from an outside.

5. The generation device according to claim 1, wherein the generation device generates the first drive signal and the second drive signal having durations based on duration data inputted from an outside.

6. The generation device according to claim 1, wherein
the generation device receives, from an outside, data indicating a plurality of inversion count values indicating timings at which the first drive signal and the second drive signal are inverted, a drive signal count value corresponding to durations of the first drive signal and the second drive signal, and a standby period count value corresponding to a duration of the standby period, and
the generation device comprises:
a counter;
a first unit configured to generate the first drive signal whose level is inverted every time a count value outputted by the counter that starts counting from an initial value matches one of count values included in the plurality of inversion count values, the first drive signal terminated in the case where the count value outputted by the counter matches the drive signal count value;
a second unit configured to terminate the standby period in a case where the count value outputted by the counter restarted from the initial value after completion of the generation of the first drive signal matches the standby period count value and to re-restart the counter from the initial value; and
a thirst unit configured to generate the second drive signal whose level is inverted every time the count value outputted by the counter re-restarted from the initial value after the termination of the standby period matches one of the count values included in the plurality of inversion count values, the second drive signal terminated in the case where the count value outputted by the counter matches the drive signal count value.

7. The generation device according to claim 1, wherein
the generation device receives, from an outside, data indicating a plurality of inversion count values indicating timings at which the first drive signal and the second drive signal are inverted, a drive signal count value corresponding to durations of the first drive signal and the second drive signal, and a standby period count value corresponding to a duration of the standby period,
the generation device comprises:
a counter;
a plurality of first comparators configured to compare a count value outputted by the counter and the plurality of inversion count values;
a second comparator configured to compare the count value outputted by the counter and the drive signal count value;
a third comparator configured to compare the count value outputted by the counter and the standby period count value;
a composition circuit configured to generate the first drive signal and the second drive signal based on a plurality of comparison results obtained by the plurality of first comparators and a comparison result obtained by the second comparator;
a switch signal generation circuit configured to generate a switch signal based on the comparison result obtained by the first comparator corresponding to the largest inversion count value among the plurality of first comparators and a comparison result obtained by the third comparator; and
a selector configured to distribute the first drive signal and the second drive signal based on the switch signal to a first heater array circuit including the plurality of first drive elements and a second heater array circuit including the plurality of second drive elements, and
the counter, the second comparator, the third comparator, and the switch signal generation circuit provide the standby period between the first drive signal and the second drive signal based on the comparison result obtained by the third comparator.

8. The generation device according to claim 1, wherein
the generation device receives, from an outside, data indicating a plurality of inversion count values indicating timings at which waveforms of the first drive signal and the second drive signal are inverted, a drive signal count value corresponding to durations of the first drive signal and the second drive signal, and a standby period count value corresponding to a duration of the standby period,
the generation device comprises:
a counter;
a plurality of first comparators configured to compare a count value outputted by the counter and the plurality of inversion count values;
a second comparator configured to compare the count value outputted by the counter and the drive signal count value;
a third comparator configured to compare the count value outputted by the counter and the standby period count value;
a flip-flop circuit configured to be set in a case where the counter starts counting and to be reset by a switch signal;
a combination circuit configured to generate the first drive signal and the second drive signal based on a plurality of comparison results obtained by the plurality of first comparators, a comparison result obtained by the second comparator, and an output of the flip-flop circuit;
a switch signal generation circuit configured to generate the switch signal that is switched based on the comparison result obtained by the first comparator corresponding to the largest inversion count value among the plurality of first comparators and a comparison result obtained by the third comparator; and
a selector configured to distribute the first drive signal and the second drive signal to a first heater array circuit including the plurality of first drive elements and a second heater array circuit including the plurality of second drive elements based on the switch signal, and
the counter, the second comparator, the third comparator, and the switch signal generation device provide the standby period between the first drive signal and the second drive signal based on the comparison result obtained by the third comparator.

9. The generation device according to claim 1, wherein
the printing element substrate is used in a first operation mode and a second operation mode in which the number of the plurality of first print elements simultaneously driven and the number of the plurality of second print elements simultaneously driven are larger than those in the first operation mode, and
the generation device sets the standby period in the second operation mode longer than the standby period in the first operation mode.

10. The generation device according to claim 9, wherein
standby period data indicating the standby period corresponding to the operation mode is received from an outside, and
the standby period is determined based on the standby period data received from the outside.

11. The generation device according to claim 9, wherein
a signal indicating the operation mode is received from the outside, and
the standby period is determined based on the operation mode.

12. A substrate comprising:
a generation device;
a plurality of first print elements;
a plurality of second print elements;
a plurality of first drive elements configured to drive the plurality of first print elements; and
a plurality of second drive elements configured to drive the plurality of second print elements, wherein
the generation device generates a first drive signal, stands by for a standby period, and then generates a second drive signal, and
at least one of the first drive elements operates based on the first drive signal or the second drive signal, and at least one of the second drive elements operates based on the first drive signal or the second drive signal.

13. The substrate according to claim 12, wherein, in a case where a selection signal indicates a first value, at least one of the first drive elements operates based on the first drive signal, and at least one of the second drive elements operates based on the first drive signal.

14. The substrate according to claim 12, wherein, in a case where a selection signal indicates a second value, at least one of the first drive elements operates based on the first drive signal, and at least one of the second drive elements operates based on the second drive signal.

15. The substrate according to claim 12, wherein, in a case where a selection signal indicates a third value, at least one of the first drive elements operates based on the second drive signal, and at least one of the second drive elements operates based on the first drive signal.

16. The substrate according to claim 12, wherein, in a case where a selection signal indicates a fourth value, at least one of the first drive elements operates based on the second drive signal, and at least one of the second drive elements operates based on the second drive signal.

17. A print head using a substrate which comprises:
a generation device;
a plurality of first print elements;
a plurality of second print elements;
a plurality of first drive elements configured to drive the plurality of first print elements; and
a plurality of second drive elements configured to drive the plurality of second print elements, wherein the generation device generates a first drive signal, stands by for a standby period, and then generates a second drive signal, and
at least one of the first drive elements operates based on the first drive signal or the second drive signal, and at least one of the second drive elements operates based on the first drive signal or the second drive signal.

18. An apparatus that performs printing on a print medium and that uses a print head which ejects an ink to print on the print medium, the print head including a substrate which comprises:
a generation device;
a plurality of first print elements;
a plurality of second print elements;
a plurality of first drive elements configured to drive the plurality of first print elements; and
a plurality of second drive elements configured to drive the plurality of second print elements, wherein
the generation device generates a first drive signal, stands by for a standby period, and then generates a second drive signal,
at least one of the first drive elements operates based on the first drive signal or the second drive signal, and at least one of the second drive elements operates based on the first drive signal or the second drive signal, and
the ink is ejected from ejection ports by driving the plurality of first print elements and the plurality of second print elements.
